(19) United States
(12) Patent Application Publication
(10) Pub. No.: US 2024/0104863 A1
(43) Pub. Date: Mar. 28, 2024

(54) CONTEXTUAL PRESENTATION OF EXTENDED REALITY CONTENT

(71) Applicant: Apple Inc., Cupertino, CA (US)

(72) Inventors: Anna L Brewer, Santa Barbara, CA (US); Elena J Nattinger, Menlo Park, CA (US); Devin W Chalmers, Oakland, CA (US)

(21) Appl. No.: 18/370,798

(22) Filed: Sep. 20, 2023

Related U.S. Application Data
(60) Provisional application No. 63/409,575, filed on Sep. 23, 2022.

(51) Int. Cl. G06T 19/00; G06T 7/11; G06T 7/73; G06V 20/20

(52) U.S. Cl. CPC G06T 19/006; G06T 7/11; G06T 7/73; G06V 20/20; G06T 2200/24

(57) ABSTRACT

Images of a physical environment are evaluated to determine candidate presentation locations for extended reality content items in an extended reality environment, each having associated presentation criteria. Extended reality content items satisfying the associated presentation criteria are presented in the extended reality environment at the candidate presentation location.

### CROSS-REFERENCE TO RELATED APPLICATION(S)

This application is a nonprovisional patent application of and claims the benefit of U.S. Provisional Patent Application No. 63/409,575, filed Sep. 23, 2022 and titled “Contextual Presentation of Extended Reality Content,” the disclosure of which is hereby incorporated herein by reference in its entirety.

### TECHNICAL FIELD

Embodiments described herein relate to the playback of extended reality content, and in particular to the identification and presentation of extended reality content to a user based on a context of the user.

### BACKGROUND

Extended reality provides an immersive user experience that shows promise for both entertainment and productivity applications. As extended reality continues to rise in popularity, there is a demand for new ways of presenting content (e.g., images, videos, etc.) in an extended reality environment that feel natural and engaging to users. Specifically, it is desirable to present content in an extended reality environment to improve perceived realism and avoid unpleasant or disruptive aspects thereof.

### SUMMARY

Embodiments described herein relate to the playback of extended reality content, and in particular to the identification and presentation of extended reality content to a user based on a context of the user. In one embodiment, an electronic device includes a set of cameras, a display, and processor communicably coupled to the set of cameras and the display. The processor may be configured to capture one or more images of a physical environment using the set of cameras and evaluate the one or more images of the physical environment to determine a set of candidate presentation locations in an extended reality environment that is based on the physical environment. Each candidate presentation location of the set of candidate presentation locations may have associated presentation criteria, which may include associated perspective criteria relative to a viewing location. For at least one of the set of candidate presentation locations, the processor may be configured to select a content item from a set of content items that satisfies the associated presentation criteria, and present the selected content item in the extended reality environment at the candidate presentation location.

In one embodiment, the associated presentation criteria further includes one or more of size criteria and environmental criteria, the environmental criteria including one or more characteristics of a location of the physical environment corresponding to the associated candidate presentation location. The one or more environmental characteristics may include an absolute location of the physical environment, one or more objects identified at the location of the physical environment, one or more people identified at the location of the physical environment, and one or more sounds identified at the location of the physical environment.

In one embodiment, identifying the content item from the set of content items that satisfies the associated presentation criteria includes identifying a number of content items from the set of content items that satisfy the associated presentation criteria. In such an embodiment, presenting the identified content item in the extended reality environment at the candidate presentation location may include presenting a user interface for selecting between the number of content items, and, on receipt of a selection of one of the content items, presenting the one of the content items in the extended reality environment at the candidate presentation location. Alternatively, the content items may be presented sequentially in the extended reality environment at the candidate presentation location.

In one embodiment, the processor is further configured to detect movement of the electronic device, and, in response to movement of the electronic device, capture one or more new images of the physical environment using the set of cameras, and evaluate the one or more new images of the physical environment to determine a new set of candidate presentation locations.

In one embodiment, evaluating the one or more images of the physical environment to determine the set of candidate presentation locations comprises determining the associated presentation criteria.

In one embodiment, the electronic device is a head-mounted device.

In one embodiment, an electronic device includes a set of cameras, a display, and processor communicably coupled to the set of cameras and the display. The processor may be configured to capture one or more images of a physical environment using the set of cameras and evaluate the one or more images of the physical environment to determine a set of candidate presentation and viewing location pairs in an extended reality environment that is based on the physical environment, each of the candidate presentation and viewing location pairs having associated presentation criteria. For at least one of the set of candidate presentation and viewing location pairs, the processor may be configured to select a content item from a set of content items that satisfies the associated presentation criteria, present an indicator in the extended reality environment at the candidate presentation location, determine a proximity of the electronic device to the candidate viewing location, and, in accordance with a determination that the electronic device is within a predetermined proximity of the candidate viewing location, present the selected content item at the candidate presentation location in the extended reality environment.

In one embodiment, the indicator is presented based on a proximity of the electronic device to the candidate presentation location. The indicator may also be presented based on the selected extended reality content item.

In one embodiment, the associated presentation criteria further includes one or more of perspective criteria relative to a viewing location, size criteria, and environmental criteria, the environmental criteria including one or more characteristics of a location of the physical environment corresponding the associated candidate presentation location. The one or more environmental characteristics may include an absolute location of the physical environment, one or more objects identified at the location of the physical environment, one or more people identified at the location of the physical environment, and one or more sounds identified at the location of the physical environment.

In one embodiment, evaluating the one or more images of the physical environment to determine the set of candidate presentation locations comprises determining the associated presentation criteria.

In one embodiment, the electronic device is a head-mounted device.

In one embodiment, an electronic device includes a set of cameras, a display, and processor communicably coupled to the set of cameras and the display. The processor may be configured to capture one or more images of a physical environment using the set of cameras and evaluate the one or more images of the physical environment to determine a set of candidate presentation and viewing location pairs in an extended reality environment that is based on the physical environment, each of the candidate presentation and viewing location pairs having associated presentation criteria. For at least one of the set of candidate presentation and viewing location pairs, the processor may be configured to select a content item from a set of content items that satisfies the associated presentation criteria, present an indicator the extended reality environment at the candidate viewing location, determine a proximity of the electronic device to the candidate viewing location, and, in accordance with a determination that the electronic device is within a predetermined proximity of the candidate viewing location, present the selected content item at the candidate presentation location in the extended reality environment.

In one embodiment, the processor is further configured to present a user interface in the extended reality environment guiding the user towards at least one candidate viewing location.

In one embodiment, the indicator is presented based on a proximity of the electronic device to the candidate viewing location. The indicator may also be presented based on the selected extended reality content item.

In one embodiment, the associated presentation criteria further includes one or more of perspective criteria relative to a viewing location, size criteria, and environmental criteria, the environmental criteria including one or more characteristics of a location of the physical environment corresponding to the associated candidate presentation location. The one or more environmental characteristics may include an absolute location of the physical environment, one or more objects identified at the location of the physical environment, one or more people identified at the location of the physical environment, and one or more sounds identified at the location of the physical environment.

In one embodiment, evaluating the one or more images of the physical environment to determine the set of candidate presentation locations comprises determining the associated presentation criteria.

In one embodiment, the electronic device is a head-mounted device.

### BRIEF DESCRIPTION OF THE DRAWINGS

Reference will now be made to representative embodiments illustrated in the accompanying figures. It should be understood that the following descriptions are not intended to limit this disclosure to one included embodiment. To the contrary, the disclosure provided herein is intended to cover alternatives, modifications, and equivalents as may be included within the spirit and scope of the described embodiments, and as defined by the appended claims.

FIG. 1 is a block diagram illustrating an electronic device, such as described herein.

FIGS. 2A and 2B illustrate capture and playback of extended reality content such as described herein.

FIGS. 3A through 3E illustrate an exemplary physical environment and corresponding extended reality environment in which extended reality content items may be presented, such as described herein.

FIG. 4 is a flow chart illustrating an exemplary method for presenting extended reality content items in an extended reality environment, such as described herein.

The use of the same or similar reference numerals in different figures indicates similar, related, or identical items.

The use of cross-hatching or shading in the accompanying figures is generally provided to clarify the boundaries between adjacent elements and also to facilitate legibility of the figures. Accordingly, neither the presence nor the absence of cross-hatching or shading conveys or indicates any preference or requirement for particular materials, material properties, element proportions, element dimensions, commonalities of similarly illustrated elements, or any other characteristic, attribute, or property for any element illustrated in the accompanying figures.

Additionally, it should be understood that the proportions and dimensions (either relative or absolute) of the various features and elements (and collections and groupings thereof) and the boundaries, separations, and positional relationships presented therebetween, are provided in the accompanying figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto.

### DETAILED DESCRIPTION

Embodiments described herein relate to the playback of extended reality content, and in particular to the identification and presentation of extended reality content to a user based on a context of the user. As discussed herein, an extended reality environment refers to a computer generated environment, which may be presented to a user as a completely virtual environment (e.g., virtual reality) or as one or more virtual elements that enhance or alter one or more real world objects (e.g., augmented reality and/or mixed reality).

As extended reality continues to grow as a user experience, it is desirable to present extended reality content in a way that is natural and engaging to a user. For example, it may be desirable to present extended reality content from the same or a similar perspective from which the content was captured, as this may provide a more realistic and thus immersive viewing experience and avoid artifacts that may result from artificially changing the size and/or perspective of the content. When viewing extended reality content, a user may be in a different location than where the content was captured. Differences between a user's current location and a capture location of extended reality content may not allow for presenting the content from a desired perspective. Principles of the present disclosure may alleviate this problem by analyzing a user's surroundings to identify content that can be displayed from the desired perspective or otherwise provide a desired viewing experience.

In one embodiment, images of a physical environment are captured by one or more cameras. The images are evaluated to determine a set of candidate presentation locations, which are locations in the physical environment suitable for presentation of extended reality content available for playback. Each candidate presentation location may have associated presentation criteria, which are criteria for extended reality content items that could or should be presented at the candidate presentation location. The associated presentation criteria may include perspective criteria relative to a viewing location, such that a given extended reality content item needs to have a particular perspective with respect to a viewing location to be presented at the candidate presentation location. For one or more of the set of candidate presentation locations, an extended reality content item may be selected from a set of extended reality content items that satisfies the associated presentation criteria. For example, an extended reality content item having a perspective with respect to a viewing location that satisfies the perspective criteria may be selected. In some cases, there will be no extended reality content items in the set of extended reality content items that satisfy the associated presentation criteria for a given candidate presentation location. The set of extended reality content items may be a local library of extended reality content items such as those captured by a user, or a remote library of extended reality content items. The selected extended reality content may then be presented in an extended reality environment that is based on the physical environment. Selecting and presenting extended reality content in this way may allow for more immersive viewing experiences, since the extended reality content is matched to particular locations in a physical environment, instead of presented arbitrarily at any location.

In some embodiments, images of the physical environment may be evaluated to determine candidate presentation and viewing location pairs, where the candidate presentation location is a location suitable for presentation of extended reality content in the physical environment, and the paired candidate viewing location is a location from which extended reality content at the candidate presentation location could or should be viewed. In some embodiments, a candidate presentation location may be associated with multiple candidate viewing locations.

In one example, a user may be in a room and wearing a head-mounted device (HMD) capable of presenting an extended reality environment. The HMD may capture images of the room and determine a candidate presentation location on the floor of the room. The HMD may determine or otherwise obtain associated presentation criteria for the candidate presentation location, such as a perspective of extended reality content relative to a viewing location of the user within the extended reality environment. For example, the HMD may identify an extended reality content item showing the user's dog playing on the floor at a different location, but captured from the same or a similar perspective relative to the viewing location. Accordingly, the HMD may present an indicator in the extended reality environment alerting the user that there is extended reality content available for playback at the candidate presentation location, or may present the extended reality content at the candidate presentation location. Since the extended reality content item has the same or a similar perspective relative to the viewing location, the user may experience improved immersion in the extended reality content item. For example, the user may feel like they are viewing their dog playing on the floor in the same way that it was originally captured.

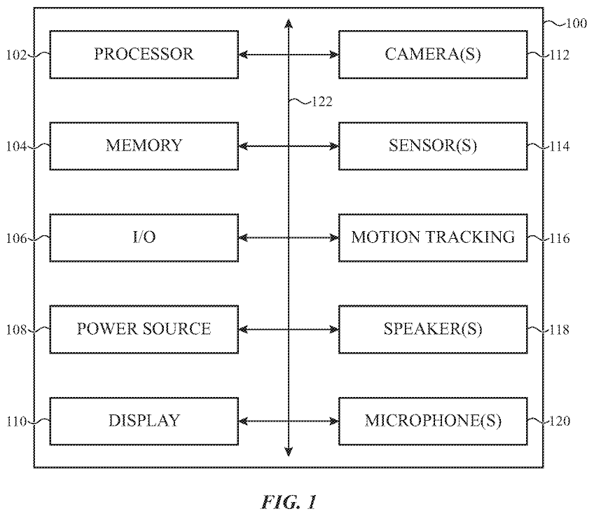

FIG. 1 is a block diagram illustrating an electronic device 100 for capturing extended reality content and/or presenting an extended reality environment according to one embodiment of the present disclosure. The electronic device 100 may include a processor 102, a memory 104, an input/output (I/O) mechanism 106, a power source 108, a display 110, one or more cameras 112, one or more sensors 114, a motion tracking system 116, one or more speakers 118, and one or more microphones 120. The processor 102, the memory 104, the I/O mechanism 106, the power source 108, the display 110, the one or more cameras 112, the one or more sensors 114, the motion tracking system 116, the one or more speakers 118, and the one or more microphones 120 may be communicably coupled via a bus 122.

The processor 102 may be configured to execute instructions stored in the memory 104 in order to provide some or all of the functionality of the electronic device 100, such as the functionality discussed herein. The processor 102 may be implemented as any electronic device capable of processing, receiving, or transmitting data or instructions, whether such data or instructions is in the form of software or firmware or otherwise encoded. For example, the processor 102 may include a microprocessor, a central processing unit (CPU), an application-specific integrated circuit (ASIC), a digital signal processor (DSP), a controller, or a combination of such devices. As discussed herein, the term processor is meant to encompass a single processing unit, multiple processors, multiple processing units, or other suitably configured computing element or elements.

In some embodiments, the components of the electronic device 100 may be controlled by multiple processors. For example, select components of the electronic device 100 such as the one or more sensors 114 may be controlled by a first processor while other components of the electronic device 100 (e.g., the display 110) may be controlled by a second processor, where the first and second processor may or may not be in communication with each other.

The memory 104 may store electronic data that can be used by the electronic device 100. For example, the memory 104 may store instructions, which, when executed by the processor 102 provide the functionality of the electronic device 100 described herein. The memory 104 may further store electrical data or content such as, for example, audio and video files, documents and applications, device settings and user preferences, timing signals, control signals, and data structures and databases. The memory 104 may include any type of memory. By way of example only, the memory 104 may include random access memory (RAM), read-only memory (ROM), flash memory, removeable memory, and/or other types of storage elements, or a combination of such memory types.

The I/O mechanism 106 may transmit or receive data from a user or another electronic device. The I/O mechanism 106 may include the display 110, a touch sensing input surface, one or more buttons, the one or more cameras 112, the one or more speakers 118, the one or more microphones 120, one or more ports, a keyboard, or the like. Additionally or alternatively, the I/O mechanism 106 may transmit electronic signals via a communications interface, such as a wireless, wired, and/or optical communications interface. Examples of wireless and wired communications interfaces include, but are not limited to, cellular and Wi-Fi communications interfaces.

The power source 108 may be any device capable of providing energy to the electronic device 100. For example, the power source 108 may include one or more batteries or rechargeable batteries. Additionally or alternatively, the power source 108 may include a power connector or power cord that connects the electronic device 100 to another power source, such as a wall outlet.

The display 110 may provide a user interface to a user of the electronic device 100. In some embodiments, the display 110 may show a portion of an extended reality environment to a user. The display 110 may be a single display or include two or more displays. For example, the display 110 may include a display for each eye of a user. The display 110 may include any type of display, including a liquid crystal display (LCD), an organic light-emitting diode (OLED) display, or any other type of display.

The one or more cameras 112 may be positioned and oriented on the electronic device 100 to capture images of an environment in which the electronic device 100 is located. In some embodiments, these images may be used to provide an extended reality experience to a user. For example, the one or more cameras 112 may be used to track objects in the environment and/or for generating a portion of an extended reality environment (e.g., by recreation of a portion of the environment within the extended reality environment). The one or more cameras 112 may be any suitable type of camera. In various embodiments, the electronic device 100 may include one, two, four, or any number of cameras. In some embodiments, some of the one or more cameras 112 may be positioned and oriented on the electronic device 100 to capture images of the user. For example, these images may be used to track a portion of the user's body, such as their eyes, mouth, cheek, arms, torso, or legs.

The one or more sensors 114 may capture additional information about the environment in which the electronic device 100 is located and/or a user of the electronic device 100. The one or more sensors 114 may be configured to sense one or more types of parameters, including but not limited to: vibration, light, touch, force, temperature, movement, relative motion, biometric data (e.g., biological parameters of a user), air quality, proximity, or position. By way of example, the one or more sensors 114 may include one or more optical sensors, a temperature sensor, a position sensor, an accelerometer, a pressure sensor, a gyroscope, a health monitoring sensor, and/or an air quality sensor. Additionally, the one or more sensors 114 may utilize any suitable sensing technology including, but not limited to, interferometric, magnetic, capacitive, ultrasonic, resistive, optical, acoustic, piezoelectric, or thermal technologies.

The motion tracking system 116 may provide motion tracking information about the electronic device 100. For example, the motion tracking system 116 may provide a position and orientation of the electronic device 100 that is either absolute or relative (e.g., an inclination and azimuth of the electronic device 100). The motion tracking system 116 may utilize any of the one or more sensors 114 to do so, or may include separate sensors for providing the motion tracking information. The motion tracking system 116 may also utilize any of the one or more cameras 112 for providing the motion tracking information, or may include one or more separate cameras for doing so.

The one or more speakers 118 may be configured to output sounds to a user of the electronic device 100. The one or more speakers 118 may be any type of speakers in any form factor. For example, the one or more speakers 118 may be configured to go on or in the ears of a user, or may be bone conducting speakers, extra-aural speakers, or the like. Further, the one or more speakers 118 may be configured to playback binaural audio to the user. The one or more microphones 120 may be positioned and oriented on the electronic device 100 to sense sound provided from the surrounding environment and/or the user. The one or more microphones 120 may be any suitable type of microphones, and may be configured to enable the electronic device 100 to record binaural sound.

The electronic device 100 may be a portable electronic device such as a smartphone, a tablet, or the like. In some embodiments, electronic device 100 may be a device that enables a user to sense and/or interact with an extended reality environment. For example, the electronic device 100 may be a projection system, a heads-up display (HUD), a vehicle window or other window having integrated display capabilities, a smartphone, a tablet, and/or a computer. In one embodiment, the electronic device 100 may be a head-mounted device such as a set of extended reality goggles. Accordingly, the electronic device 100 may include a housing configured to be provided on or over a portion of a face of a user, and one or more straps or supports for holding the electronic device 100 in place when worn by the user. Further, the electronic device 100 may be configured to completely obscure the surrounding environment from the user (e.g., using an opaque display to provide a VR experience), or to allow the user to view both the surrounding environment with virtual content overlaid thereon (e.g., using a semi-transparent display to provide an AR experience), and may allow switching between the two. However, the principles of the present disclosure apply to electronic devices having any form factor.

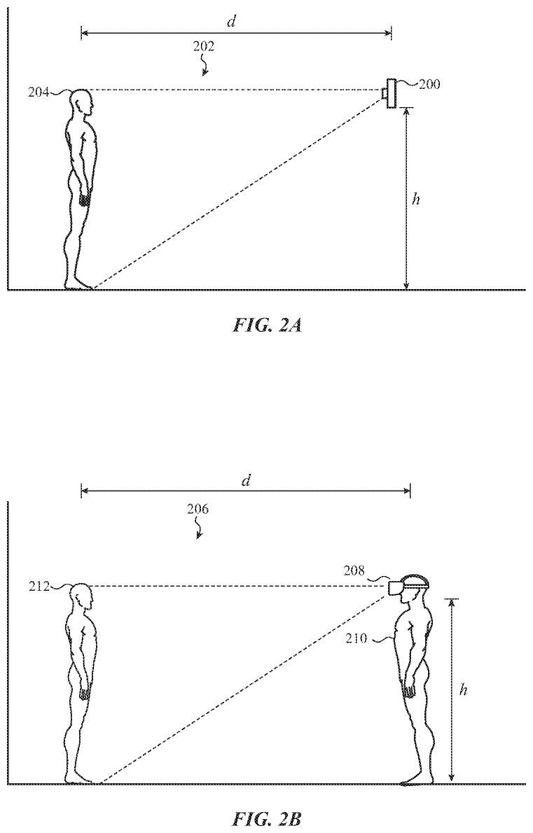

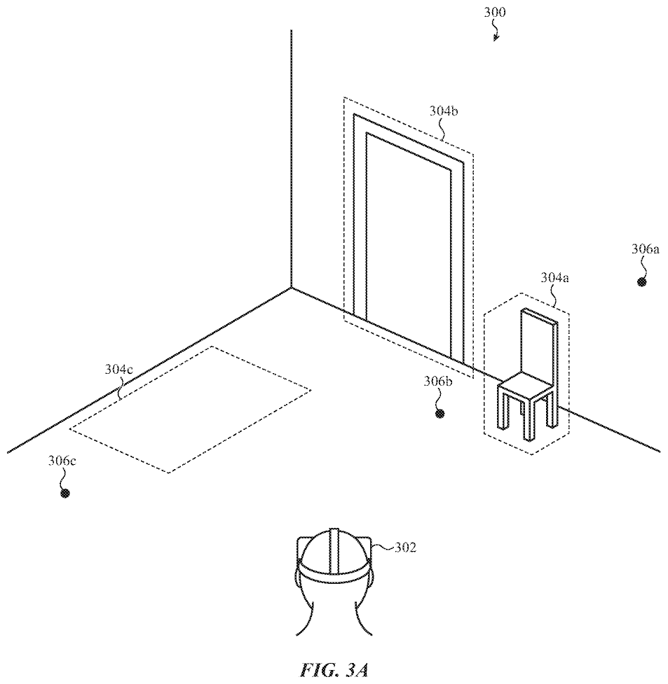

FIGS. 2A and 2B illustrate the general concept of capturing and playing back extended reality content to maintain a perspective of the content. As shown in FIG. 2A, a camera 200 captures one or more images (e.g., a still image, a video, or the like) of a physical environment 202 including a subject 204 to generate content as described herein. The camera 200 is located at a particular distance d from the subject 204, is being held at a particular height h from the ground. The camera 200 also may have a particular orientation with respect to the subject 204 and/or the physical environment 202 (e.g., a particular vertical and horizontal tilt). This creates a perspective with respect to the subject 204 and the rest of the physical environment 202.

FIG. 2B shows playback of the content captured by the camera 200 in an extended reality environment 206 generated by an HMD 208 worn by a user 210. Specifically, the extended reality environment 206 may present the content captured by the camera 200 in FIG. 2A. This may include presenting a picture or a video that includes a representation 212 of the subject 204. If the HMD 208 is positioned at the same height h as the camera 200, the content may be positioned within the extended reality environment 212 such that the representation 212 of the subject 204 is positioned at the same relative distance d and orientation from the HMD 208 as the subject 204 was positioned relative to the camera 200 in the physical environment 202. The user may perceive from the representation 212 of the subject 204 from the same perspective of the camera 200 that was used to capture the content, which may provide a more lifelike reproduction 212 of the subject 204 within the extended reality environment 206 (e.g., the subject 204 appears to be standing on the floor and is sized at the same scale as if the subject were actually positioned at that location). Accordingly, the devices, systems and methods described here are configured to present content in a manner that maintains the capture perspective for a given item of content.

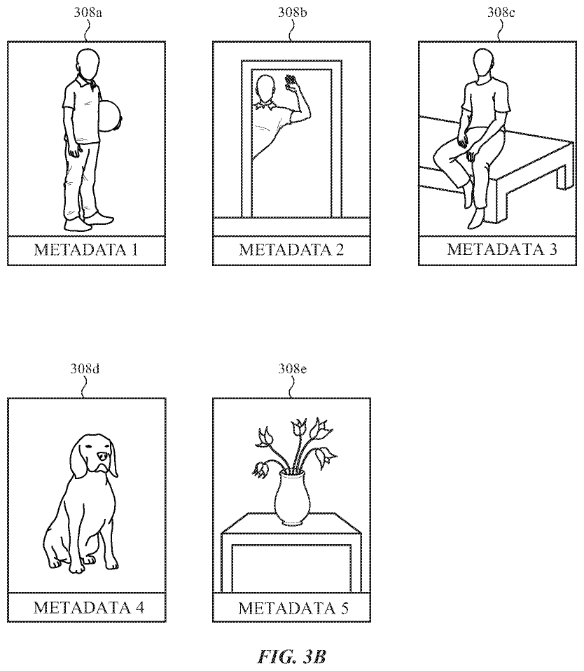

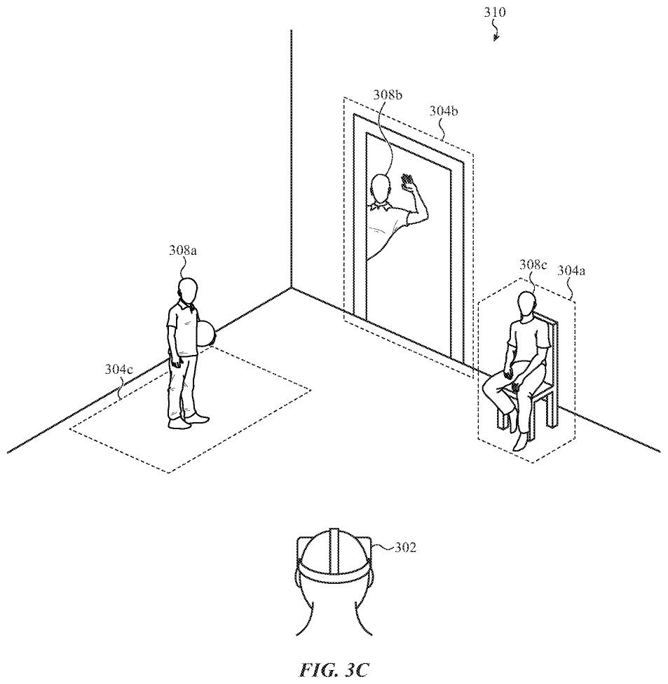

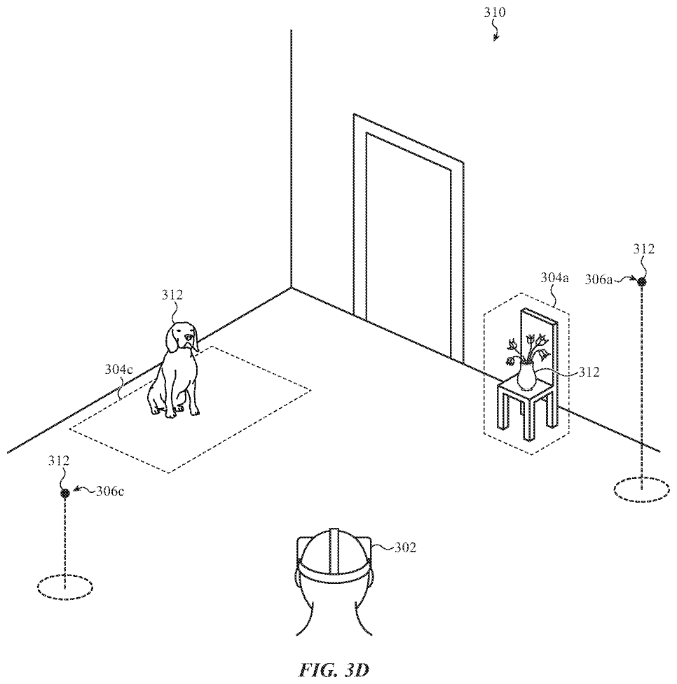

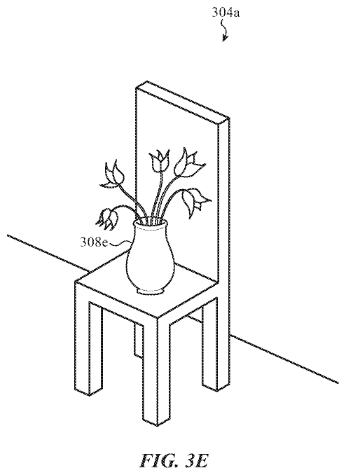

FIG. 3A illustrates an exemplary physical environment 300 being evaluated for candidate presentation locations by an electronic device 302. While the electronic device 302 is shown as an HMD for purposes of illustration, the electronic device 302 may comprise any type of electronic device. The electronic device 302 may be configured as discussed above with respect to FIG. 1. As shown, the physical environment 300 includes a number of objects and surfaces, including a number of walls, a floor, a doorway, and a chair. A number of candidate presentation locations 304 (individually labeled as 304a-304c) identified by the electronic device 302 are illustrated with dashed boxes in the physical environment 300. While three candidate presentation locations 304 are shown for purposes of illustration, at times zero candidate presentation locations 304, one candidate presentation location 304, or any other number of candidate presentation locations 304 may be identified depending on the content of the physical environment around the electronic device 302. The candidate presentation locations 304 are locations at which extended reality content could be presented by the electronic device 302 in an extended reality environment that is generated based on the physical environment 300. Each of the candidate presentation locations 304 may also have a paired candidate viewing location 306 (individually labeled as 306a-306c), which are illustrated with dots in the physical environment 300. The candidate viewing locations 306 are locations associated with a candidate presentation location 304 at which a user should be located (and, in particular, a position at which the user's head should be located) to view content at the candidate presentation location 304 with a desired viewing experience (e.g., from a desired perspective). While the candidate viewing locations 306 are shown at a particular point in space, the candidate viewing locations 306 may also be associated with some area surrounding the point in various embodiments. In some embodiments, a candidate presentation location 304 may have multiple candidate viewing locations 306, representing multiple perspectives from which different content could be viewed at a given candidate presentation location 304 with a desired viewing experience.

The candidate presentation locations 304 and the candidate viewing locations 306 may be determined by evaluating one or more images of the physical environment 300 captured by the electronic device 302. For example, images of the physical environment 300 may be divided into regions, each of which is analyzed to determine associated presentation criteria. The associated presentation criteria may describe the type of extended reality content or one or more attributes of extended reality content that could be presented within the region so as to maintain a perspective of the content or otherwise provide a desirable viewing experience. In some embodiments, each of the regions are analyzed to identify specific features within the physical environment 300, such as open floors, different types of furniture, or the like. The associated presentation criteria may be based on these identified features.

The candidate presentation locations 304 may represent a subset of all locations in the physical environment 300 available for presentation of extended reality content. In some embodiments, identifying the candidate presentation locations 304 may include ranking available locations for presentation of content (e.g., from least to most specific associated presentation criteria) and selecting the top candidates, or filtering from a larger set of available locations in the physical environment 300 in any suitable manner. As the electronic device 302 moves (e.g., due to movement of a user of the electronic device 302), new images of the physical environment 300 may be captured, and new candidate presentation locations 304 and, optionally, candidate viewing locations 306 may be determined based on the updated images. Notably, the dashed boxes and dots shown in FIG. 3A are not presented to the user of the electronic device 302, but merely represent the candidate presentation locations 304 and candidate viewing locations 306, respectively, identified by the electronic device 302 and are shown for purposes of illustration.

In some embodiments, the candidate presentation locations 304 and viewing locations 306 may be determined based on presentation attributes associated with one or more extended reality content items in a set of extended reality content items (e.g., in a library of extended reality content items on the electronic device 302). For example, locations in the physical environment 300 may be evaluated to identify candidate presentation locations 304 such that when viewed from a candidate viewing location 306, a perspective of the candidate presentation location 304 will be the same as or similar to a perspective of an extended reality content item in the set of extended reality content items.

FIG. 3B illustrates a set of extended reality content items 308 (individually labeled as 308a through 308e). Each of the extended reality content items 308 may include associated presentation attributes, which may describe features of the extended reality content item 308 that may affect the presentation thereof in an extended reality environment, such as a perspective from which the extended reality content item was captured. In some embodiments, the associated presentation attributes may be described in metadata (represented as “METADATA 1”-“METADATA 5” for each of the content items 308a-308e, respectively). However, the associated presentation attributes may be stored or otherwise associated with an extended reality content item 308 in any suitable manner. Associated presentation attributes may further include, for example, a pose of one or more people in the content item, one or more objects in the content item (e.g., a piece of furniture, a toy, etc.), a time at which the content item was captured, an absolute location at which the content item was captured, a type of environment in which the content item was captured, and one or more other environmental characteristics of a physical environment in which the content item was captured (e.g., is the environment indoors, at the beach, at a park, in the forest). The associated presentation attributes may be matched with associated presentation criteria for a content presentation location to determine if an extended reality content item is able to be presented at the content presentation location, as discussed in further detail below.

FIG. 3C illustrates an exemplary extended reality environment 310 presented to a user by the electronic device 302. In particular, FIG. 3C illustrates an exemplary extended reality environment 310 in which extended reality content items 308 are presented at candidate presentation locations 304 in the extended reality environment 310. As shown, a first one of the extended reality content items 308a is presented at a third one of the candidate presentation locations 304c, a second one of the extended reality content items 308b is presented at a second one of the candidate presentation locations 304b, and a third one of the extended reality content items 308c is presented at a first one of the candidate presentation locations 304a. Notably, while an extended reality content item 308 is shown in each candidate presentation location 304, in some cases there may not be an extended reality content item 308 that matches the associated presentation criteria for a given candidate presentation location 304, and thus nothing may be presented there.

Notably, one or more subjects in an extended reality content item 308 may be segmented and presented in the extended reality environment 310 so as to blend in with the extended reality environment 310. For example, a person in the extended reality content item 308 may be segmented from other objects or a background in the extended reality content item 308 and presented within the extended reality environment 310. As a specific example, while the third one of the extended reality content items 308c shows a person sitting on a bed, the person may be segmented from the bed and background and presented in the extended reality environment 310 to appear as if they are sitting on a chair that is present in the physical environment 300. This may represent a case where the third one of the extended reality content items 308c includes an associated presentation attribute describing that a subject therein is sitting, and the first one of the candidate presentation locations 304a includes associated presentation criteria describing that it contains a surface suitable for sitting. Similarly, a person in the second one of the extended reality content items 308b may be segmented from a doorway in the extended reality content item and presented to appear as if they are in a doorway in the physical environment 300.

In some embodiments, one or more subjects may be segmented from an extended reality content item 308, but the non-segmented subject matter of the extended reality content item 308 (e.g., the background) may still be presented in the extended reality environment 310. In these embodiments, one or more visual effects may be applied to the non-segmented part of the extended reality content item 308. For example, the non-segmented part of the extended reality content item 308 may be blurred, darkened, or otherwise altered to delineate the subject from the rest of the content. Additionally, one or more characteristics of the extended reality content item 308 may be changed to blend the segmented subject or other parts of the extended realty content item 308 in with the extended reality environment 310. For example. one or more lighting effects may be applied to the segmented subject or the entirety of the content in order to seamlessly blend the content into the extended reality environment 310.

In some embodiments, a user may be able to apply filters to the type of extended reality content items 308 displayed in the extended reality environment 310. For example, a user may be able to specify that they would only like to see extended reality content items 308 including a certain person or persons, or extended reality content items 308 in a particular environment (e.g., in an indoor environment). These criteria may be used to determine the set of extended reality content items 308 available to display in the extended reality environment 310.

In FIG. 3C, a content item is selected for and presented at each of the candidate presentation locations. For example, a first content items 308a is presented at presentation location 304c, a second content item 308b is presented at presentation location 304b, and a third content item 308c is presented at presentation location 304a. Each content item is selected as meeting the associated presentation criteria for the candidate presentation location it is shown in. In particular, each of the extended reality content items 308a-308c may meet the associated presentation criteria for the candidate presentation location 304 at which they are shown and a paired candidate viewing location, which may be the location at which the electronic device 302 is currently located. Accordingly, each one of the extended reality content items 308 may be presented in the extended reality environment 310 in a way that preserves the perspective they were captured from, or any other desired viewing experience. However, in some cases it may be the case that the electronic device 302 is not located in a correct viewing location with respect to a candidate presentation location 304 for a given extended reality content item 308. In these cases, an indicator may be presented in the extended reality environment 310 to alert the user that there is a better viewing location or that there is content available for viewing at a candidate presentation location 304, if they move to the correct location. This is illustrated in FIG. 3D.

As shown in FIG. 3D, indicators may be presented at either a candidate presentation location 304, a candidate viewing location 306, or both, to indicate that content is available for viewing at a candidate presentation location 304. Specifically, FIG. 3D shows indicators 312, which are illustrated as floating orbs but could be represented in any suitable manner (e.g., by any shape or graphic), presented in a first one of the candidate viewing locations 306a and a third one of the candidate viewing locations 306c in the extended reality environment 310. Further, indicators 312 are presented in the first one of the candidate presentation locations 304a and the third one of the candidate presentation locations 304c. The indicators in the candidate presentation locations 304 may be based on one or more extended reality content items that meet the associated presentation criteria for the location. For example, an indicator representing a fifth one of the extended reality content items 308e is shown at the first one of the candidate presentation locations 304a and an indicator representing a fourth one of the extended reality content items 308d is shown at the third one of the candidate presentation locations 304c. The fifth one of the extended reality content items 308e and the fourth one of the extended reality content items 308d may be altered with one or more visual effects to appear blurred or desaturated, for example, in order to provide the indicators associated therewith. In some embodiments, indicators in the candidate presentation locations 304 may not be based on one or more extended reality content items matching the associated presentation criteria, but instead may be a generic indicator (e.g., a floating orb or other shape/graphic). In various embodiments, indicators may be presented at only the candidate presentation locations 304, only the candidate viewing locations 306, or at both the candidate presentation locations 304 and the candidate viewing locations 306.

The indicators 312 may change in response to a proximity of the electronic device 302, and thus the user, to the candidate presentation location 304 and/or candidate viewing location 306. For example, the indicators 312 may get bigger, brighter, or more saturated as the electronic device 302 gets closer to the candidate presentation location 304 and/or candidate viewing location 306. This may assist the user in getting into the correct position for viewing content at a candidate presentation location 304. In some embodiments, a graphical user interface directing the user towards a particular location or guiding them to position their head in a particular manner may be presented in the extended reality environment 310.

In some embodiments, when the electronic device 302 gets within a predetermined proximity of a candidate presentation location 304 and/or candidate viewing location 306, an extended reality content item matching the associated presentation criteria is presented at the candidate presentation location 304. This is illustrated in FIG. 3E, which shows the fifth one of the extended reality content items 308e being presented at the first one of the candidate presentation locations 304a, representative of the case when the electronic device 302 is within a predetermine proximity to the first one of the candidate presentation locations 304a and/or first one of the candidate viewing locations 306a. While the fifth one of the extended reality content items 308e may show a vase located on a table, in the present embodiment the vase is segmented from the table and any background content and presented on a chair in the physical environment 300, on which the extended reality environment 310 is based. The vase may be presented in this manner when the electronic device 302 gets within a certain distance of the first one of the candidate presentation locations 304a and/or first one of the candidate viewing locations 306a and is oriented in a particular way so as to preserve a perspective of the fifth one of the extended reality content items 308e.

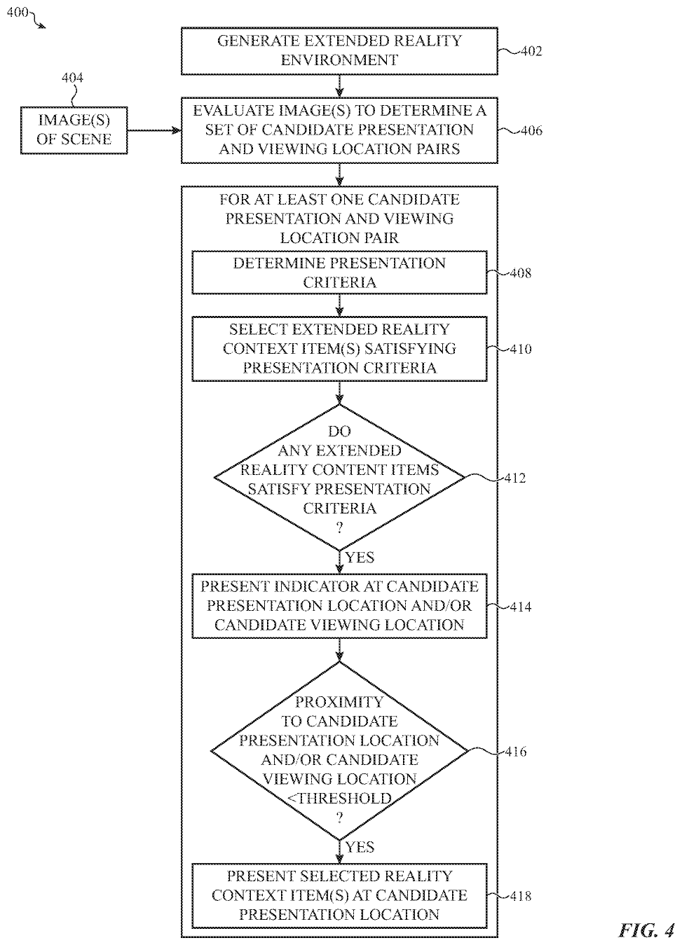

FIG. 4 is a flow chart illustrating an exemplary method 400 for presenting extended reality content in an extended reality environment, which may be performed by an electronic device such as the electronic device 100 described in FIG. 1. An extended reality environment is generated (block 402). The extended reality environment may be generated by one or more processors in an electronic device presenting the extended reality environment to a user, or by a remote device (e.g., by one or more processing resources instantiated by hardware in a remote server). Generating the extended reality environment may include creating, or otherwise accessing, a representation of the extended reality environment such that the extended reality environment can be presented to the user.

One or more images of a physical environment may be obtained (block 404). The one or more images may be obtained by a camera or set of cameras that art part of the electronic device, or by other cameras in communication with the electronic device. The one or more images of the physical environment may be evaluated to identify a set of candidate presentation locations and, optionally, paired candidate viewing locations (block 406). Notably, the set of candidate presentation locations may include only one candidate presentation location. In some embodiments, a candidate presentation location may be associated with or paired with a number of candidate viewing locations (such that a given candidate presentation location is present in a number of candidate presentation and viewing location pairs). The candidate presentation locations are locations in the physical environment at which extended reality content items could or should be presented. The candidate viewing locations are locations from which a paired candidate presentation location could or should be viewed, for example, to maintain a desired perspective or other desired viewing experience. Evaluating the images to determine the candidate presentation locations and, optionally, candidate viewing locations, may include dividing the images into regions, each of which is analyzed to determine associated presentation criteria. In some embodiments, each of the regions are analyzed to identify specific features within the physical environment, such as open floors, different types of furniture, or the like. The associated presentation criteria may be based on these identified features. Evaluating the one or more images of the physical environment may be performed locally at the electronic device, or may be performed at one or more remote devices (e.g., by transferring the images and any other required information to the one or more remote devices). In various embodiments, evaluating the images may include classifying an environment in the images (e.g., whether the environment is indoors, outdoors, or in a particular type of location such as a home, in an office, etc.), classifying object types in the images, classifying surface types in the images (e.g., seating surfaces, desks, walls, etc.), determining a time of day, time of year, season in the images, or any other classification/evaluation.

In some embodiments, the candidate presentation locations and, optionally, candidate viewing locations may be determined based on presentation attributes associated with a set of extended reality content items (e.g., in a library of extended reality content on the electronic device). For example, candidate presentation locations and candidate viewing locations may be identified in the one or more images of the physical environment based on a number of perspectives represented by the extended reality content items in the set of extended reality content items. Specifically, candidate presentation locations and candidate viewing locations may be identified such that a perspective of the candidate presentation location from the candidate viewing location is the same or similar to a perspective of an extended reality content item in the set of extended reality content items.

The remaining blocks occur for at least one candidate presentation and viewing location pair. Accordingly, when the remaining blocks reference “the candidate presentation viewing location” and “the candidate viewing location,” they are referencing the candidate presentation location and the candidate viewing location being currently being operated on by the method 400. When candidate viewing locations are not determined in block 406 above, the remaining blocks of the method may apply only to the candidate presentation location. Associated presentation criteria may be determined for the candidate presentation location and/or the candidate viewing location (block 408). Determining the associated presentation criteria may be performed locally at the electronic device, or by one or more remote devices. Determining the associated presentation criteria may include analyzing the one or more images of the physical environment, the candidate presentation location, and/or the candidate viewing location to determine criteria for extended reality content items that could or should be presented there. For example, determining the associated presentation criteria may include analyzing a relationship between the candidate presentation location and the candidate viewing location to determine a perspective relative to the candidate viewing location that extended reality content items should match in order to be presented at the candidate presentation location, identifying one or more surfaces or objects at the candidate presentation location, or the like.

The associated presentation criteria may include perspective criteria relative to a viewing location. The viewing location may be the candidate viewing location, or any fixed viewing location. The presentation criteria may indicate a desired perspective for extended reality content presented at the candidate presentation location relative to the viewing location, such that extended reality content items must have the same or a similar perspective, for example, relative to a capture location (e.g., a camera or cameras that captured the extended reality content item) to be presented there. In some embodiments, the perspective criteria may specify a relative distance and orientation from the viewing location at which a presented content item will have a target perspective relative to the viewing location (e.g., the perspective from which the content item was originally captured or another desired perspective as may be selected for a given content item). The presentation criteria may further include one or more of a size criteria, which indicates a desired size of extended reality content items to be presented at the candidate presentation location relative to the viewing location, an environmental criteria, which may include one or more environmental characteristics of a location of the physical environment corresponding to the candidate presentation location. The environmental criteria may include an absolute location of the physical environment, one or more objects identified at the location of the physical environment, one or more people identified at the location of the physical environment, one or more sounds identified at the location of the physical environment, or any other characteristics of the physical environment (e.g., is the environment indoors, at the beach, at a park, in the forest).

One or more extended reality content items may be selected from a set of extended reality content items which satisfy the associated presentation criteria (block 410). Selecting extended reality content items which satisfy the associated presentation criteria may include comparing one or more presentation attributes associated with the extended reality content items (e.g., size, perspective, orientation, content, a pose of a user in the content item, one or more objects in the content item, an absolute location at which the content item was captured, one or more environmental characteristics of an environment in which the content item was captured) with one or more criteria in the associated presentation criteria. For example, a perspective of an extended reality content item with respect to a capture location (e.g., a camera or cameras that captured the extended reality content item) may be compared with a desired perspective indicated in perspective criteria in the associated presentation criteria. If the perspective of the extended reality content item satisfies the perspective criteria, the extended reality content item may be selected. In some embodiments, multiple extended reality content items may be selected for a given candidate presentation and viewing location pair. In other embodiments, only one extended reality content item is selected for a given candidate presentation and viewing location pair. In various embodiments, certain criteria of the associated presentation criteria may be optional, such that an extended reality content item can still be presented at a candidate presentation location even if presentation attributes associated with the content item do not meet the criteria (e.g., the associated presentation criteria describes a surface that a person can sit on, while the associated presentation attributes do not describe a person sitting). Other criteria of the associated presentation criteria may be mandatory such that a content item cannot be presented at a candidate presentation location unless the presentation attributes associated with the content item meet the criteria. Still other criteria of the associated presentation criteria may be presented in a Boolean fashion requiring some or all of a subset of criteria to be met in order to present an extended reality content item at a candidate presentation location.

In some embodiments, the set of extended reality content items may be a library of extended reality content items stored locally on the electronic device presenting the extended reality environment to the user (e.g., extended reality content items captured by the user). In other embodiments, the set of extended reality content items may be from a remote source. Selecting the one or more extended reality content items that match the associated presentation criteria may be performed locally at the electronic device or at one or more remote devices.

In some situations, there will be no extended reality content items that satisfy the associated presentation criteria. Accordingly, a determination may be made whether any extended reality content items match the associated presentation criteria (block 412). If there are no extended reality content items in the set of extended reality content items that match the associated presentation criteria, the process may break, such that there is no further processing of the candidate presentation and viewing location pair, and nothing is presented at the candidate presentation location and/or candidate viewing location in the extended reality environment.

If there is at least one extended reality content item that matches the associated presentation criteria, an indicator may be presented in the extended reality environment at the candidate presentation location and/or the candidate viewing location (block 414). The indicator may be any suitable size or shape, and may preview or otherwise indicate the content of the one or more selected extended reality content items. In general the indicator may signal to the user that there is extended reality content available for viewing at the candidate presentation location (optionally, from the candidate viewing location). The indicator may change based on a proximity of the electronic device or user to the candidate presentation location and/or the candidate viewing location. In some embodiments, the indicator is a graphical user interface that guides or otherwise directs the user towards the candidate presentation location and/or the candidate viewing location. The indicator may also guide or direct the user to position the electronic device (which, in the case of an HMD, may also include positioning their head) in a particular position or orientation relative to the candidate presentation location for optimal viewing of the selected extended reality content items. In some embodiments, block 414 is omitted, and no indicators are presented in the extended reality environment.

Optionally, a determination may be made whether the electronic device or the user are proximate to (e.g., within a predetermined proximity of) a candidate presentation location and/or candidate viewing location (block 416). If the electronic device or user is proximate to the candidate presentation location and/or candidate viewing location (or regardless, if block 416 is omitted), the selected extended reality content items may be presented at the candidate presentation location (block 418). In the case that multiple extended reality content items are selected for a candidate presentation and viewing location pair, a user interface may be presented at the candidate presentation location allowing a user to select between the selected extended reality content items. Alternatively, the selected extended reality content items may be presented sequentially at the candidate presentation location. A user interface allowing a user to control presentation of the selected extended reality content items may also be presented (e.g., a user interface allowing a user to play, pause, fast forward, and rewind the selected extended reality content items). The selected extended reality content items may be presented based on a proximity of the electronic device and/or user to the candidate presentation location and/or candidate viewing location. For example, a selected extended reality content item may be paused and/or blurred when the electronic device or the user are relatively far away from the candidate presentation location and/or candidate viewing location, and resume playing or become less blurred as the electronic device or the user move closer to the candidate presentation location and/or candidate viewing location.

As discussed above, presenting an extended reality content item in the extended reality environment may include segmenting one or more subjects in the extended reality content item and presenting only the segmented subjects. Alternatively, the segmented subjects may be presented differently from non-segmented content (e.g., the non-segmented content may be presented with one or more visual effects applied thereto).

Thus, it is understood that the foregoing and following descriptions of specific embodiments are presented for the limited purposes of illustration and description. These descriptions are not targeted to be exhaustive or to limit the disclosure to the precise forms recited herein. To the contrary, it will be apparent to one of ordinary skill in the art that many modifications and variations are possible in view of the above teachings.

As used herein, the phrase “at least one of” preceding a series of items, with the term “and” or “or” to separate any of the items, modifies the list as a whole, rather than each member of the list. The phrase “at least one of” does not require selection of at least one of each item listed; rather, the phrase allows a meaning that includes at a minimum one of any of the items, and/or at a minimum one of any combination of the items, and/or at a minimum one of each of the items. By way of example, the phrases “at least one of A, B, and C” or “at least one of A, B, or C” each refer to only A, only B, or only C; any combination of A, B, and C; and/or one or more of each of A, B, and C. Similarly, it may be appreciated that an order of elements presented for a conjunctive or disjunctive list provided herein should not be construed as limiting the disclosure to only that order provided.

One may appreciate that although many embodiments are disclosed above, that the operations and steps presented with respect to methods and techniques described herein are meant as exemplary and accordingly are not exhaustive. One may further appreciate that alternate step order or fewer or additional operations may be required or desired for particular embodiments.

Although the disclosure above is described in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the some embodiments of the invention, whether or not such embodiments are described and whether or not such features are presented as being a part of a described embodiment. Thus, the breadth and scope of the present invention should not be limited by any of the above-described exemplary embodiments but is instead defined by the claims herein presented.

Principles of the present disclosure may be implemented as instances of purpose-configured software, and may be accessible, for example, via API as a request-response service, an event-driven service, or configured as a self-contained data processing service. In other words, a person of skill in the art may appreciate that the various functions and operations of a system such as described herein can be implemented in a number of suitable ways, developed leveraging any number of suitable libraries, frameworks, first or third-party APIs, local or remote databases (whether relational, NoSQL, or other architectures, or a combination thereof), programming languages, software design techniques (e.g., procedural, asynchronous, event-driven, and so on or any combination thereof), and so on. The various functions described herein can be implemented in the same manner (as one example, leveraging a common language and/or design), or in different ways. In many embodiments, functions of a system described herein are implemented as discrete microservices, which may be containerized or executed/instantiated leveraging a discrete virtual machine, that are only responsive to authenticated API requests from other microservices of the same system. Similarly, each microservice may be configured to provide data output and receive data input across an encrypted data channel. In some cases, each microservice may be configured to store its own data in a dedicated encrypted database; in others, microservices can store encrypted data in a common database; whether such data is stored in tables shared by multiple microservices or whether microservices may leverage independent and separate tables/schemas can vary from embodiment to embodiment. As a result of these described and other equivalent architectures, it may be appreciated that a system such as described herein can be implemented in a number of suitable ways. For simplicity of description, many embodiments that follow are described in reference an implementation in which discrete functions of the system are implemented as discrete microservices. It is appreciated that this is merely one possible implementation.

As described herein, the term “processor” refers to any software and/or hardware-implemented data processing device or circuit physically and/or structurally configured to instantiate one or more classes or objects that are purpose-configured to perform specific transformations of data including operations represented as code and/or instructions included in a program that can be stored within, and accessed from, a memory. This term is meant to encompass a single processor or processing unit, multiple processors, multiple processing units, analog or digital circuits, or other suitably configured computing element or combination of elements.

What is claimed is:

1. An electronic device, comprising:
a set of cameras;
a display; and
a processor communicably coupled to the set of cameras and the display, the processor configured to:
capture one or more images of a physical environment using the set of cameras;
evaluate the one or more images of the physical environment to determine a set of candidate presentation locations in an extended reality environment that is based on the physical environment, each candidate presentation location of the set of candidate presentation locations having associated presentation criteria, the associated presentation criteria including perspective criteria relative to a viewing location;
for at least one of the set of candidate presentation locations:
identify a content item from a set of content items that satisfies the associated presentation criteria; and
present the identified content item in the extended reality environment at the candidate presentation location.

2. The electronic device of claim 1, wherein the associated presentation criteria further includes one or more of size criteria or environmental criteria, the environmental criteria including one or more characteristics of a location of the physical environment corresponding to the candidate presentation location.

3. The electronic device of claim 2, wherein the one or more characteristics of the environment comprise:
one or more characteristics of the physical environment;
an absolute location of the physical environment;
one or more objects identified at the location of the physical environment;
one or more people identified at the location of the physical environment; or
one or more sounds identified at the location of the physical environment.

4. The electronic device of claim 1, wherein identifying a content item from a set of content items that satisfies the associated presentation criteria comprises identifying a plurality of content items from the set of content items that satisfy the associated presentation criteria, and wherein presenting the identified content item in the extended reality environment at the candidate presentation location comprises:
presenting a user interface in the extended reality environment for selecting between the plurality of content items; and
on receipt of a selection of one of the plurality of content items from the user, present the one of the plurality of content items in the extended reality environment at the candidate presentation location.

5. The electronic device of claim 1, wherein identifying a content item from a set of content items that satisfies the associated presentation criteria comprises identifying a plurality of content items from the set of content items that satisfy the associated presentation criteria, and wherein presenting the identified content item in the extended reality environment at the candidate presentation location comprises presenting each of the plurality of content items sequentially in the extended reality environment at the candidate presentation location.

6. The electronic device of claim 1, wherein the processor is further configured to:
detect movement of the electronic device; and
in response to the detection of movement of the electronic device:
capture one or more new images of the physical environment using the set of cameras; and
evaluate the one or more new images of the physical environment to determine a new set of candidate presentation locations.

7. The electronic device claim 6, wherein evaluating the one or more images of the physical environment to determine the set of candidate presentation locations comprises determining the associated presentation criteria.

8. The electronic device of claim 1, wherein the electronic device is a head-mounted device.

9. The electronic device of claim 1, wherein:
each content item of the set of content items is associated with one or more presentation attributes; and
identifying the content item from the set of content items that satisfies the associated presentation criteria is based on the one or more associated presentation attributes of the content item.

10. The electronic device of claim 9, wherein the one or more presentation attributes comprise:
a pose of a person in the content item;
one or more objects in the content item;
a time at which the content item was captured;
an elevation at which the content item was captured;
an absolute location at which the content item was captured; or
one or more characteristics of the physical environment in which the content item was captured.

11. The electronic device of claim 1, wherein presenting the identified content item in the extended reality environment comprises segmenting a subject of the content item and presenting the segmented subject of the content item in the extended reality environment.

12. The electronic device of claim 11, wherein presenting the identified content item in the extended reality environment further comprises presenting a portion of the content item outside the segmented subject in the extended reality environment with one or more visual effects applied thereto.

13. The electronic device of claim 1, wherein presenting the identified content item in the extended reality environment comprises adjusting one or more visual attributes of the content item to blend the identified content item into the extended reality environment.

14. An electronic device, comprising:
a set of cameras;
a display; and
a processor communicably coupled to the set of cameras and the display, the processor configured to:
capture one or more images of a physical environment using the set of cameras;
evaluate the one or more images of the physical environment to determine a set of candidate presentation and viewing location pairs in an extended reality environment that is based on the physical environment, each of the set of candidate presentation and viewing location pairs having associated presentation criteria;
for at least one of the set of candidate presentation and viewing location pairs:
select a content item from a set of content items that satisfies the associated presentation criteria;
present an indicator in the extended reality environment at the candidate presentation location;
determine a proximity of the electronic device to the candidate viewing location; and
in accordance with a determination that the electronic device is within a predetermined proximity of the candidate viewing location, present the content item at the candidate presentation location in the extended reality environment.

15. The electronic device of claim 14, wherein the processor is further configured to present the indicator based on the proximity of the electronic device to the candidate presentation location.

16. The electronic device of claim 14, wherein the processor is further configured to present the indicator based on the selected content item.

17. The electronic device of claim 14, wherein the associated presentation criteria includes one or more of:
size criteria;
perspective criteria relative to the candidate viewing location; or
environmental criteria including one or more characteristics of a location of the physical environment corresponding to the associated candidate presentation location.

18. The electronic device of claim 17, wherein the one or more characteristics of the environment comprise:
one or more characteristics of the physical environment;
an absolute location of the physical environment;
one or more objects identified at the location of the physical environment;
one or more people identified at the location of the physical environment; or
one or more sounds identified at the location of the physical environment.

19. The electronic device of claim 14, wherein evaluating the one or more images of the physical environment to determine the set of candidate presentation and viewing location pairs comprises determining the associated presentation criteria.

20. The electronic device of claim 14, wherein the processor is further configured to:
detect movement of the electronic device; and
in response to the detection of movement of the electronic device:
capture one or more new images of the physical environment using the set of cameras; and
evaluate the new one or more images of the updated physical environment to determine a new set of candidate presentation locations.
